(19) United States
(12) Patent Application Publication
(10) Pub. No.: US 2011/0085850 A1
(43) Pub. Date: Apr. 14, 2011

(54) TRACK CONNECTION ELEMENT

(75) Inventors: Christoph WIEDNER, Feldkirch (AT); Marc Nutzmann, Lindau (DE); Hermann Fritz, Landsberg (DE)

(73) Assignee: Hilti Aktiengesellschaft, Schaan (LI)

(21) Appl. No.: 12/899,887

(22) Filed: Oct. 7, 2010

(30) Foreign Application Priority Data
Oct. 8, 2009 (DE) 10 2009 045 474.8

(51) Int. Cl. F16B 21/00; F16B 17/00

(52) U.S. Cl. 403/315; 403/345

(57) ABSTRACT

A track connection element for positioning a track body, which exhibits an interior, on a hanging element is disclosed. The track connection element exhibits two sidewalls, distanced from each other, which both exhibit an insertion section for insertion of the track connection element into the interior and a connection section connecting the sidewalls, which section has a recess for the hanging element. The sidewalls are reduced in terms of height in certain areas in the area of the insertion section. Further, a fastening device with such a track connection element is disclosed.

This application claims the priority of German Patent Document No. 10 2009 045 474.8, filed Oct. 8, 2009, the disclosure of which is expressly incorporated by reference herein.

### BACKGROUND AND SUMMARY OF THE INVENTION

The invention concerns a track connection element. Furthermore, the invention concerns a fastening device with such a track connection element.

To fix a track body distanced from a structural component such as a ceiling, they are fixed by means of fixing apparatuses, e.g., with nuts and washers, to mostly rod-shaped hanging elements such as threaded rods, which elements are passed through the interior of the track body by means of mounting openings on the track body opposing each other. For example, conduits, e.g., tubes or channels, are mounted directly or on stilts on the track body.

The disadvantage of this known solution is that the fixing must be distanced from the end of the track body and therefore more track material is used than is required for the mounting. In addition, this type of fixing requires a variety of individual parts, to be mounted separately, that are also to be mounted in a specific sequence.

A U-shaped track connection element for positioning of a track body, which possesses an interior accessible via the ends of the track body and via multiple mounting openings distanced from each other, on a hanging element is available on the market with the name METU System MS from the company METU Meinig AG. The track connection element is positioned on the cut-off end of the track body. The track connection element exhibits two sidewalls distanced from each other that each have an insertion section formed according to the interior of the track body for insertion of the track connection element at the end of the track body in its interior and a connection section connecting the sidewalls, which section exhibits a holder for the hanging element. So that the insertion sections can engage in the interior of the track body, they are formed slightly conically, which is why the track connection element must be inserted sufficiently deeply into the track body with forceful hammer strikes. Then, by means of a threaded rod as a hanging element passed through the holder of the track connection element a nut is screwed onto this rod as a fixing element and the track body is fixed at the desired height.

The disadvantage of this known solution is that the track connection element substantially completely fills out the end section of the track body and specifically the interior of the track body in the end area at the sidewalls so that on the corresponding end section of the track body no fastening means can be positioned to fix conduits or additional hangings.

It is the task of the invention to create a track connection element that does not have the aforementioned disadvantages and that specifically enables the positioning of fastening elements in the end area of the track body in a mounted state. Furthermore, it is the task of the invention to create a positioning with such a track connection element.

According to the invention, at least one of the sidewalls is reduced in terms of height in the area of the insertion section in certain areas.

By means of the reduced height, a free space is present in the interior of the track body that enables the arrangement of fastening elements with rear gripping sections, such as track nuts with rear gripping parts or tube clamps with rear gripping hooking elements, so-called strut clamps, despite the track connection element positioned at the end of the track body. The area is advantageously provided with the reduced height between the end of the insertion section coming to rest in the track body and distanced from the connection section. Therefore at the end coming to rest in the track body and at the end of the track body more material sections of the insertion section of the sidewalls are present that based on their contact in the interior of the track body guarantee a sufficient fixing of the track body to the hanging element.

Furthermore, the force required to position the track connection element on the end of the track body based on the friction surface reduced in comparison to the known track connection element is so low that the track connection element can be inserted sufficiently deeply into its interior, e.g., by hand, without the assistance of an additional tool at the end of the track body.

Preferably, at least one blocking element is provided at at least one of the sidewalls in the area of the insertion section, which element forms a safety against unintended movement or against releasing the track connection element from the track body.

Preferably, the at least one blocking element is a tab protruding from the sidewall, which in a mounted state at least sectionally comes into contact with a section at the interior side of the track body. The free end of the tab is advantageously aligned into the interior of the track body counter to the insertion direction of the track connection element.

Preferably, at least one holder recess in the area of the connection section is provided for a fixing element positionable on the hanging element, which recess enables a secure positioning of the fixing element on the track connection element and therefore an advantageous fixing of the track body to the hanging element. The at least one holder recess is advantageously provided at the end of the holder for the hanging element, which in a mounted state faces downward or to the ground. In an advantageous embodiment, on both ends of the holder for the hanging element a holder recess is provided for a fixing element in each case so that with respect to the positioning of the track connection element at the end of the track body is not necessary to consider any particular alignment of it.

Preferably, at least one abutment section is provided at at least one of the sidewalls which section can be brought into contact with the corresponding end of the track body and prevents an excessively deep insertion of the track connection element into the track body. The insertion section of the sidewall therefore extends from the free end of the sidewall to the abutment section provided at the corresponding sidewall, which section is provided for adjacent to the free end of the sidewall. On both sidewalls of the track connection element at least one abutment section in each case is preferably provided for. The at least one abutment section is in each case formed from a tab advantageously aligned inward and formed at the corresponding sidewall. If both sidewalls exhibit at least one abutment section formed in each case as a tab, then these tabs are advantageously aligned inward and are further advantageously arranged so as to be facing each other.

An inventive fastening device to fasten a track body, which has an interior accessible through the ends of the track body and through at least one mounting opening with an interior height, to a hanging element exhibits at least one fixing element for positioning on the hanging element and a track connection element with one or all of the aforementioned features. At least one of the sidewalls of the track connection element possesses in the area of the insertion section in certain areas a height that is lower than the corresponding interior height of the interior of the track body.

The height of the area reduced in terms of height is selected advantageously coordinated to the shape of the interior and the mounting openings of the track body so that a fastening element insertable into the mounting openings can continue to be arranged with its anchoring sections in the end area of the track body.

Preferably, the track body has a C-shaped cross-section with a mounting opening running in the longitudinal direction of the track body and the relevant interior height of the track body extends to the free end of the edge section of the track body bordering the mounting opening. Such track bodies are also designated mounting tracks and distinguish themselves by their flexibility with respect to the positioning of fastening elements along the longitudinal direction of the track body.

Preferably, the track body exhibits at least in certain areas a profile and the at least one blocking element can be brought into contact with the profile whereby an advantageous safety of the inserted track connection element is guaranteed in the track body. With respect to a track body with C-shaped cross-section, the profile is advantageously a toothing, which is provided for, for example, at the free end, advantageously aligned inward, of the edge sections bordering the mounting opening. If the at least one blocking element is a tab protruding from the sidewalls, then in a mounted state of the track body element advantageously the free end of the tab engages with the profile.

Preferably, the at least one fixing element is a rapid assembly nut that can be simply and quickly positioned on the hanging element. For example, the rapid assembly nut has a slot running in the direction of the bore axis so that the at least one fixing element can be pushed up sideways at any point on the hanging element. Such an arrangement is especially advantageous if, distanced from an already fixed track body at the same hanging elements, again a track body is to be fastened, for example, between the already fixed track body and the structural component, like a ceiling, on which the hanging elements are positioned. Alternatively, the rapid assembly nut is a tilting nut, which has a slanted bore and threaded sections positioned opposite each other. Such a rapid assembly nut is pushed tilted over the hanging element compared to a horizontal line and after reaching the desired position is tipped so that its threaded sections come into contact with the exterior of the hanging element, which advantageously has threading. If the hanging element has an exterior threading, the rapid assembly nut advantageously can be screwed onto this. Further, with respect to an inventive fastening device a standard nut can be used as the fixing element where the positioning of the same on the hanging element is substantially more time-consuming compared to the positioning of a rapid assembly nut.

Preferably, the rapid assembly nut has at least one collar section which in a mounted state advantageously penetrates the holder of the connection section of the track connection element. The collar section coming to rest in the holder, in a mounted state of the rapid assembly nut, prevents the nut from being opened unintentionally. Advantageously, the rapid assembly nut has a collar section on both sides so that with respect to its arrangement on the hanging element is not necessary to consider any special orientation of the rapid assembly nut.

The invention is further explained below by means of an embodiment.

### BRIEF DESCRIPTION OF THE DRAWINGS

FIG. 1 is a track connection element in perspective view;

FIG. 2 is a perspective view of an arrangement with the track connection element according to FIG. 1;

FIG. 3 is a longitudinal section through the arrangement according to FIG. 2 along the track body;

FIG. 4 is a cross-section through the arrangement according to FIG. 2 along line IV-IV in FIG. 3; and

FIG. 5 is a fixing element in a perspective view for an arrangement according to FIG. 2.

### DETAILED DESCRIPTION OF THE DRAWINGS

In principle, the same parts with the same reference numbers are provided in the figures.

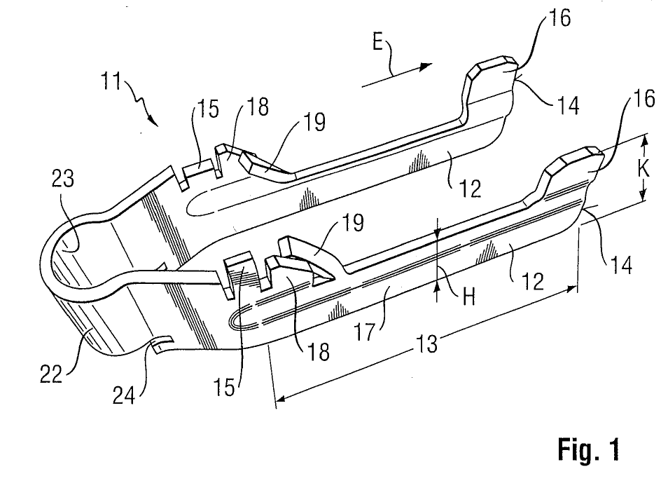

The track connection element 11 represented in FIG. 1 for positioning a track body 31 on a hanging element 41 is formed in a U-shape and has two sidewalls 12 distanced from each other as well as a connection section 22 connecting the sidewalls 12, which section has a holder 23 for the hanging element 41. The hanging element 41 is a threaded rod which is fastened to a structural component not depicted here, e.g., a ceiling.

The sidewalls 12 of the track connection element 11 each have an insertion section 13 formed according to the interior 32 of the track body 31. The insertion section 13 extends from the free end 14 up to an abutment section 15 provided on the corresponding sidewall, which section comes into contact with the end 33 during insertion of the track connection element 11 at the end 33 of the track body into its interior 32 and prevents an excessively deep insertion of the track connection element 11. The abutment section 15 is formed in each case from a tab aligned inward and formed on the corresponding sidewall 12, so that the tabs face each other.

The sidewalls 12 are each reduced in the area of the insertion section 13 in certain areas at the height H. Each sidewall 12 therefore exhibits at its free end 14 a first holding section 16 with a height K, connecting to it an undercut section 17 with the height H reduced from height K, and connecting to it a second holding section 18 with height K. Height K of the first holding section 16 or a second holding section 18 corresponds advantageously to the maximum interior height I of the interior 32 of the track body 31.

At each sidewall 12 in the area of the undercut section 17 on its side set back across from the first holding section 16 and the second holding section 18 a blocking element 19 is also provided for. The blocking element is a tab protruding from the sidewall 12 which is aligned inward and counter to the insertion direction of the track connection element 11.

In the area of the connection section 22, which borders the holder 23, a holder recess 24 is provided for a fixing element 46 positionable on the hanging element 41.

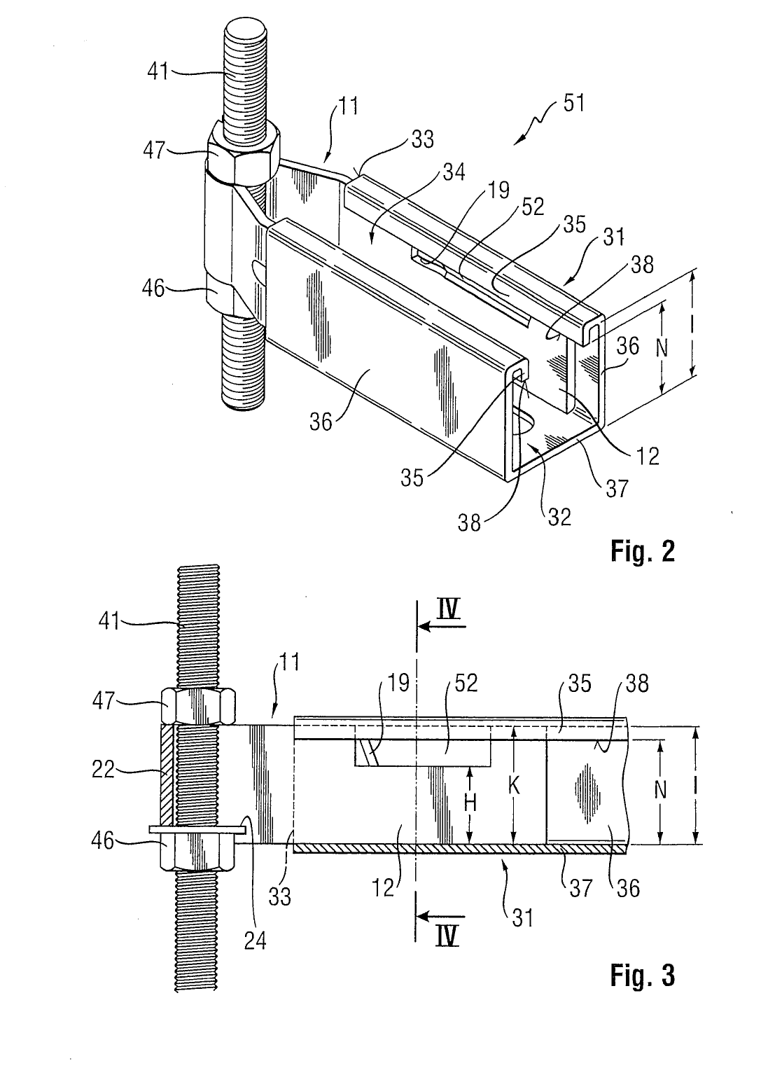

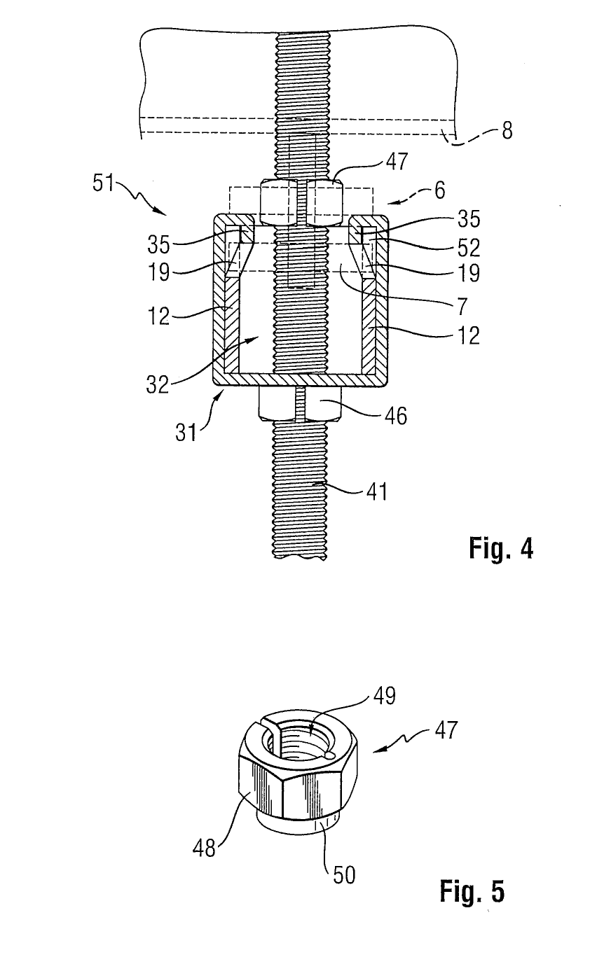

The fastening device 51 represented in FIGS. 2 through 5 comprises a track connection element 11 and two rapid assembly nuts as fixing elements 46 and 47 that are positionable for fixing the track body 31 to the hanging element 41.

The C-shaped track body 31 exhibits two parallel sidewalls 36 and a ground section 37 connecting the sidewalls 36. Opposite the ground section 37 is provided a mounting opening 34 running in the longitudinal direction of the track body 31, which opening is bordered on the side by edge sections 35 protruding inward. At the free ends of the edge sections 35 bordering the mounting opening 34 a toothing is provided as a profile 38.

The C-shaped track body 31 surrounds an interior 32 that is accessible via the end 33 by the track body 11 and via the mounting opening 34. The interior 32 exhibits a maximum interior height I and in the area of the edge sections 35 bordering the mounting opening 34 an interior height N.

The height H of the undercut section 17 of the track connection element 11 is chosen such that in a mounted state of the track connection element 11 a sufficiently large free space 52 is present so that a fastening element 6 with a rear gripping part 7 can be positioned in the near-end area of the track body 31 for fastening a conduit 8.

The fixing element 47 represented by FIG. 5 is a rapid assembly nut that has a slotted base body 48 with an exterior contour exhibiting a rotational entrainment surface and an interior bore 49, which is equipped with internal threading. Further, a collar section 50 surrounding the bore 49 protrudes on the base body 48.

To position the track connection element 11, it is slipped forward via the hanging element 41 with the free ends 14 of the sidewalls 12 and pushed into the interior 32 accessible via the end 33 of the track body 31. Because the sidewalls 12 in the area of the undercut section 17 have a reduced friction area compared to the remaining insertion section 13 of the sidewall 12 with the internal side of the track body, the track connection element 11 can be inserted by hand into the interior of the track body.

During insertion of the track connection element 11, the blocking elements 19 formed on the sidewalls 12 come into contact with the profile 38 at the edge sections 35 of the track body 31 and are displaced counter to the insertion direction E. When the track connection element 11 with the abutment sections 15 stands at the end 33 of the track body 31, an unintentional movement of the track connection element 11 out of the track body 31 is prevented through blocking elements 19 hooked with the profile 38 to the edge sections 35 of the track body 31.

The fixing element 46 is pushed or clipped onto the hanging element 41 adjacent to the track connection element 11 and is screwed up to the desired height or up to the desired distance from a structural component not depicted here along the hanging element 41. Subsequently or during the screwing process, the fixing element 46 engages in the holder recess 24 of the track connection element 11. With a second fixing element 47, which is positioned on the hanging element 41 in reference to the drawing above the track connection element 11, the track body 31 is secured in the desired orientation on the hanging element 41.

Fastening elements 6 can now be provided on the track body 31 despite the positioned fastening device 51 up to the near-end area of the track body 31.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A track connection element, comprising:
two sidewalls distanced from each other, wherein each of the two sidewalls has an insertion section; and
a connection section connecting the two sidewalls, wherein the connection section has a holder;
wherein at least one of the two sidewalls is reduced in terms of height in an area of the insertion section.

2. The track connection element according to claim 1, wherein a blocking element is provided on at least one of the two sidewalls in the area of the insertion section.

3. The track connection element according to claim 2, wherein the blocking element is a tab protruding from the at least one of the two sidewalls.

4. The track connection element according to claim 1, wherein a recess is provided in an area of the connection section.

5. The track connection element according to claim 1, wherein an abutment section is provided on at least one of the two sidewalls.

6. A fastening device, comprising:
a track body that has an interior and an interior height;
a track connection element insertable into the interior of the track body and including:
two sidewalls distanced from each other; and
a connection section connecting the sidewalls, wherein the connection section has a holder;
wherein at least one of the two sidewalls has in an area of an insertion section a height that is lower than the interior height of the track body; and
a hanging element with a fixing element, wherein the hanging element is disposable within the holder.

7. The fastening device according to claim 6, wherein the track body has a C-shaped cross-section with a mounting opening running in a longitudinal direction of the track body.

8. The fastening device according to claim 6, wherein the track body has a profile and wherein a blocking element provided on the at least one of the two sidewalls in the area of the insertion section is engageable with the profile.

9. The fastening device according to claim 6, wherein the fixing element is a nut.
